(19) United States
(12) Patent Application Publication
(10) Pub. No.: US 2007/0247875 A1
(43) Pub. Date: Oct. 25, 2007

(54) Multiple-Output Voltage Converter

(75) Inventors: Bernd Ackermann, Aachen (DE); Henricus Petronella Maria Derckx, Heerlen (NL); Wilhelmus Johannes Robertus Van Lier, Heerlen (NL); Miguel Rubio, Cambrils (ES); Eberhard Waffenschmidt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,240

(22) PCT Filed: May 25, 2005
(86) PCT No.: PCT/IB05/51712

§ 371 Date: Dec. 8, 2006

(30) Foreign Application Priority Data
Jun. 8, 2004 (EP) 04102602.2

(51) Int. Cl. H02M 3/335

(52) U.S. Cl. 363/16

(57) ABSTRACT

The present invention relates to a multiple-output voltage converter. A basic idea of the present invention is to provide a multiple-output converter which may be adapted to various output power conditions. The converter has, in an exemplifying embodiment, three outputs which all share a common tapped inductor (301, 302). An inductor tap is employed to control the inductance of the inductor. A large inductance is used for low power standby operation and a small inductance is used when, for example, the LED backlight is switched on. Switches are arranged at the converter outputs to select to which one of the respective converter outputs the energy of the inductor is to be transferred.

The present invention relates to a multiple-output voltage converter.

In many electronic devices, voltages differing from the battery voltage of the device are required. As an example, a monochrome mobile phone display module requires three different output voltages: one voltage for the light-emitting diode (LED) backlight and two voltages for the liquid crystal display (LCD). Actually, the output to which the LED backlight is connected is operated as a current source and not as a voltage source. State of the art circuits for providing these three voltages involve the use of three separate converters, e.g. three boost converters.

However, each of these converters requires an inductor that is bulky and costly. Therefore, in the next generation of devices, a new topology will be used where the converters for the three outputs are operated time-sequentially and share a common inductor.

In the above example of a mobile phone display module, the LED backlight needs much more power than the LCD. In standby mode, the LED backlight is switched off and the display module requires only a small amount of power. The display module needs much more power when the LED backlight is switched on. In both cases, the power supply must be very efficient for a long standby time to be attained.

An object of the present invention is to provide a voltage conversion circuit which is flexible and operates in an efficient manner for different load conditions. This object is attained by a multiple-output converter in accordance with claim 1.

According to a first aspect of the invention, there is provided a multiple-output voltage converter comprising a converter input, a number of converter outputs, a switching arrangement, an inductor and a first switching means. The inductor is connected to the converter input, and is arranged such that its inductance can be controlled during operation of the converter. The first switching means is arranged at the inductor to transfer energy stored in the inductor to the switching arrangement, which switching arrangement is arranged at the converter outputs to selectively transfer the stored energy to at least one of the number of converter outputs.

A basic idea of the present invention is to provide a multiple-output converter which may be adapted to various output power conditions. A number of outputs share a common inductor. For such a design to operate efficiently under different load conditions, this inductor must have a variable inductance, preferably a large inductance for low power operation such as the mobile display standby mode and a small inductance for high power operation such as that of the mobile display when the LED backlight is switched on.

The converter has, in an exemplifying embodiment, three outputs which all share a common tapped inductor. An inductor tap is employed to control the inductance of the inductor. Switches are arranged at the converter outputs to select to which one of the respective converter outputs the energy of the inductor is to be transferred.

The present invention is advantageous, particularly so in display drivers for mobile LCD displays which must provide very low power in standby mode and high power when the backlight is turned on. In both these cases, it is desirable to accomplish high efficiencies. With the multiple-output converter of the present invention, which converter is arranged with a single tapped inductor, the inductance can be optimally adapted to output power conditions and component count, volume and costs are minimized.

Further features of, and advantages with, the present invention will become apparent when studying the appended claims and the following description. Those skilled in the art realize that different features of the present invention can be combined to create embodiments other than those described in the following.

The preferred embodiments of the present invention will be described in detail with reference made to the accompanying drawings, in which:

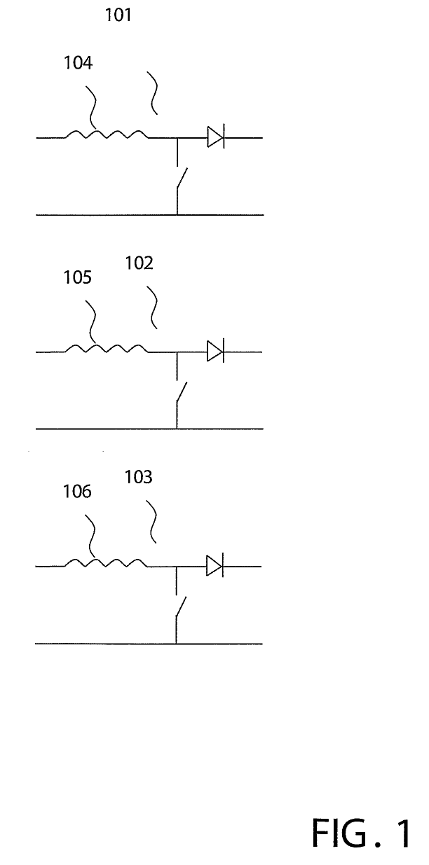

FIG. 1 shows a prior art multiple-output voltage converter;

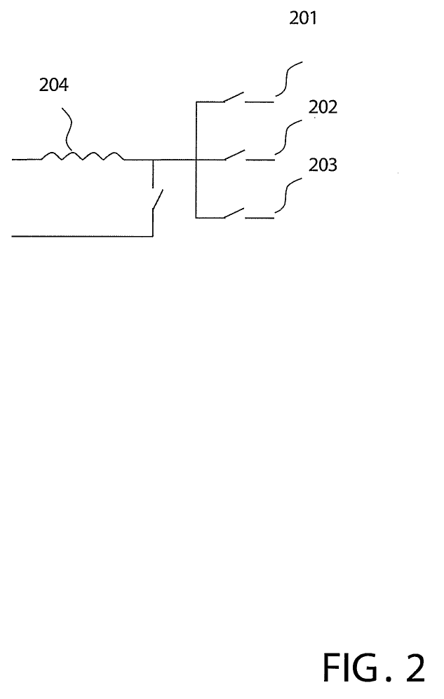

FIG. 2 shows another prior art multiple-output voltage converter; and

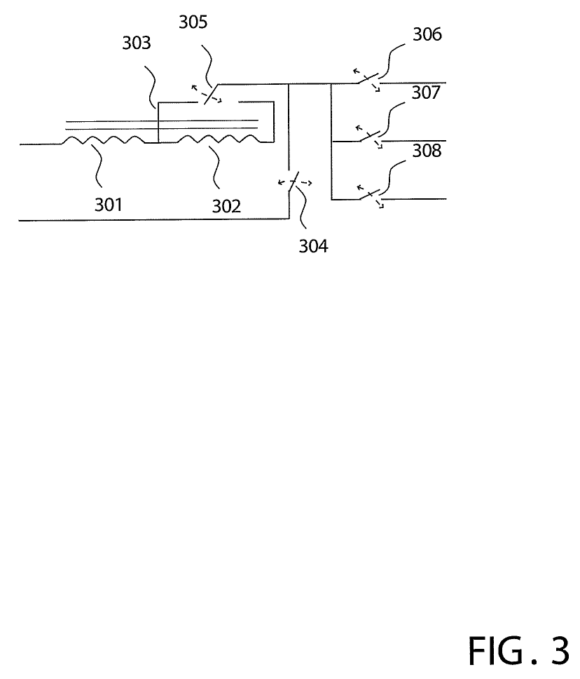

FIG. 3 shows a multiple-output voltage converter in accordance with an embodiment of the present invention.

FIGS. 1 and 2 each show prior art solutions for converting a voltage input into three different voltage outputs. The converters may be applied in an electronic device, e.g. a mobile phone. FIG. 1 shows a circuit comprising three different converters 101, 102, 103 each having one inductor 104, 105, 106 (which circuit hence has three outputs), and FIG. 2 shows another converter that also has three outputs 201, 202, 203, but which comprises only one single inductor 204.

FIG. 3 shows a multiple-output converter in accordance with an embodiment of the present invention. This multiple-output converter may, as outlined previously, be used in a multiple-output power supply for a monochrome mobile phone display module. It may also be used in multiple-output power supplies for other subsystems of mobile phones and other portable devices that have to operate with a high efficiency both in a high power normal mode of operation and a low power standby mode of operation.

An inductor is shown having two windings 301, 302 wound in series on a common core. An inductor tap 303 is utilized to control the inductance of the inductor. A first switch 304, for example implemented by means of a transistor, is employed to charge/discharge the inductor.

The number of turns of the left winding 301 is N1 and the number of turns of the right winding 302 is N2. The right winding may be disconnected by a second switch 305. If the switch is placed in the right position, i.e. in a first state, then the two windings are connected in series and the inductance of the inductor is (assuming that the windings are ideally coupled) AL*(N1+N2)ˆ2, where AL is the AL-value of the core and denotes the inductance obtained when a winding with a single turn is wound on this core. If the switch is in the left position, i.e. in a second state, then the right winding 302 is disconnected and the inductance of the inductor is AL*N1ˆ2. This inductance is typically much smaller than AL*(N1+N2)ˆ2. If leakage flux is taken into consideration, i.e. it is assumed that the windings are not ideally coupled, the inductance of the inductor would be expressed as AL*N1ˆ2+ALS1 *N1ˆ2 (when the right winding is disconnected) and AL*(N1+N2)ˆ2+ALS1*N1ˆ2+ALS2*N2ˆ2 (when both windings are connected in series). ALS1 and ALS2 denotes an “additional” AL-value of the corresponding winding with regard to the leakage flux. However, quite often ALS1 and ALS2 will be small compared with AL.

This specific converter has three outputs and a corresponding switch 306, 307, 308 arranged at each output to couple an input voltage to any one, or more, of the converter output(s).

When a power source is applied to the converter input, and the first switch 304 is closed, current flows through the inductor and as a result, energy is stored in the inductor. If the second switch 305 is placed in the second state, energy is stored in the left winding 301 of the inductor as well as in the right winding 302. Should the second switch 305 be placed in its first state, energy is only stored in the left winding 301. When the first switch is opened, and any one of the output switches 306, 307, 308 is closed, the energy stored in the inductor is transferred to the converter output that corresponds to the closed output switch. If two or more output switches are closed, the energy is transferred to the corresponding converter outputs.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A multiple-output voltage converter comprising:
a converter input;
a number of converter outputs;
a switching arrangement (306, 307, 308);
an inductor (301, 302) connected to the converter input, which inductor is arranged such that its inductance can be controlled during operation of the converter; and
a first switching means (304) arranged at the inductor to transfer energy stored in the inductor to the switching arrangement, which switching arrangement is arranged at the converter outputs to selectively transfer the stored energy to at least one of the number of converter outputs.

2. The multiple-output voltage converter according to claim 1, wherein said inductor (301, 302) is arranged with a first terminal, a second terminal and a tap terminal, the first inductor terminal being connected to a first converter input terminal, said converter further comprising:
a second switching means (305) connected to the second inductor terminal or the tap terminal, said second switching means being connected in series with the first switching means (304) which is connected to a second converter input terminal, wherein the second switching means controls the inductance of the inductor.

3. The multiple-output voltage converter according to claim 2, wherein said second switching means (305) is connected in a first state to the second inductor terminal and in a second state to the tap terminal, wherein the second switching means controls the inductor (301, 302) to have a first inductance in the first state and a second inductance in the second state.

4. The multiple-output voltage converter according to claim 2, wherein said switching arrangement comprises a plurality of different output switching means (306, 307, 308) each having a first and a second terminal, the second terminal of each output switching means being connected to the second switching means (305) and the first switching means (304), and the first terminal of each output switching means being connected to the corresponding converter output.

5. The multiple-output voltage converter according to claim 3, wherein
a second terminal of said second switching means (305) is connected in the first state to the second inductor terminal and in the second state to the tap terminal;
a first terminal of said second switching means is connected to a second terminal of the first switching means (304), a first terminal of which first switching means being connected to the second converter input terminal; and
the first terminal of said second switching means and the first terminal of the first switching means is connected to the second terminal of each output switching means (306, 307, 308).

6. The multiple-output voltage converter according to claim 1, wherein the switching means (304, 305, 306, 307, 308) comprise transistors.

7. A display driver for a mobile LCD, including a multiple-voltage converter according to claim 1.
